(19) United States
(12) Patent Application Publication
(10) Pub. No.: US 2014/0021811 A1
(43) Pub. Date: Jan. 23, 2014

(54) PERMANENT MAGNET (PM) ELECTRIC MACHINE INCLUDING PERMANENT MAGNETS PROVIDED WITH A SACRIFICAL COATING HAVING A THERMAL INTERFACE MATERIAL (TIM)

(71) Applicant: Remy Technologies, L.L.C., Pendleton, IN (US)

(72) Inventors: Colin Hamer, Noblesville, IN (US); Bradley D. Chamberlin, Pendleton, IN (US); Koon Hoong Wan, Fishers, IN (US)

(21) Appl. No.: 13/943,988

(22) Filed: Jul. 17, 2013

Related U.S. Application Data
(60) Provisional application No. 61/672,451, filed on Jul. 17, 2012.

(51) Int. Cl. H02K 9/22; H02K 15/02

(52) U.S. Cl. CPC H02K 9/22; H02K 15/024
USPC 310/52; 29/598

(57) ABSTRACT

A permanent magnet electric machine including a housing, a stator mounted within the housing, and a rotor assembly rotatably mounted within the housing relative to the stator. The rotor assembly includes a plurality of laminations. Each of the plurality of laminations includes a plurality of slots and one or more permanent magnets mounted within respective ones of the plurality of slots. Each of the plurality of permanent magnets includes a sacrificial coating formed from a thermal interface material (TIM).

### CROSS-REFERENCE TO RELATED APPLICATION

This application is a Non-Provisional of U.S. Provisional Application No. 61/672,451 filed Jul. 17, 2012, the disclosure of which is incorporated by reference herein in its entirety.

### BACKGROUND OF THE INVENTION

Exemplary embodiments pertain to the art of electric machines and, more particularly, to a permanent magnet electric machine including permanent magnets provided with a sacrificial coating having a thermal interface material (TIM).

Electric machines produce work from electrical energy passing through a stator to induce an electro-motive force in a rotor. The electro-motive force creates a rotational force at the rotor. The rotation of the rotor is used to power various external devices. Of course, electric machines can also be employed to produce electricity from a work input. In either case, electric machines are currently producing greater outputs at higher speeds and are being designed in smaller packages. In the case of permanent magnet electric machines, magnets are being designed to possess a higher flux density in a smaller form-factor. Such magnets generally are formed from, or include various rare earth metals.

### BRIEF DESCRIPTION OF THE INVENTION

Disclosed is a permanent magnet electric machine including a housing, a stator mounted within the housing, and a rotor assembly rotatably mounted within the housing relative to the stator. The rotor assembly includes a plurality of laminations. Each of the plurality of laminations includes a plurality of slots and one or more permanent magnets mounted within respective ones of the plurality of slots. Each of the one or more permanent magnets includes a sacrificial coating having a thermal interface material (TIM).

Also disclosed is a rotor for a permanent magnet electric machine including a plurality of laminations having a plurality of slots, and one or more permanent magnets mounted within respective ones of the plurality of slots. Each of the one or more permanent magnets includes a sacrificial coating having a thermal interface material (TIM).

Further disclosed is a method of constructing a rotor for a permanent magnet electric machine. The method includes stacking a plurality of rotor laminations, aligning a plurality of slots formed in each of the plurality of rotor laminations, joining the plurality of rotor laminations to form a rotor body, inserting one or more permanent magnets including a sacrificial coating having a thermal interface material (TIM) into respective ones of the plurality of slots, and removing a portion of the sacrificial coating through an interaction between each of the one or more permanent magnets and one or more of the plurality of rotor laminations to establish an interference fit with the rotor body.

### BRIEF DESCRIPTION OF THE DRAWINGS

The following descriptions should not be considered limiting in any way. With reference to the accompanying drawings, like elements are numbered alike:

FIG. 1 depicts a cross-sectional side view of a permanent magnet electric machine in accordance with an exemplary embodiment;

FIG. 2 depicts a perspective view of a rotor of the permanent magnet electric machine of FIG. 1;

FIG. 3 depicts a permanent magnet having a sacrificial coating including a thermal interface material (TIM) in accordance with an exemplary embodiment; and

FIG. 4 depicts a partial cross-sectional view of the rotor of FIG. 2 illustrating insertion of the permanent magnets of FIG. 3.

### DETAILED DESCRIPTION OF THE INVENTION

A detailed description of one or more embodiments of the disclosed apparatus and method are presented herein by way of exemplification and not limitation with reference to the Figures.

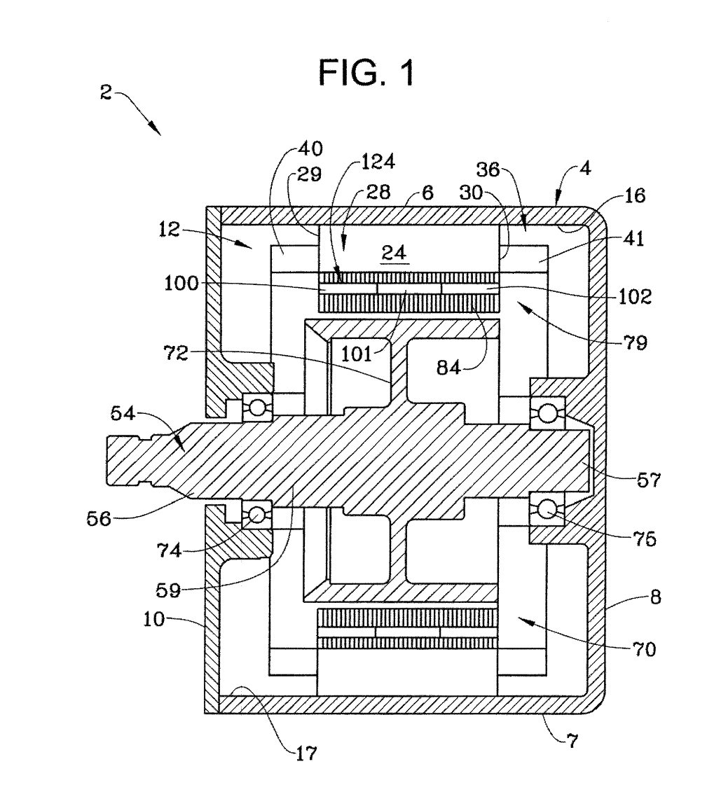

A permanent magnet electric machine in accordance with an exemplary embodiment is indicated generally at 2 in FIG. 1. Electric machine 2 includes a housing 4 having first and second side walls 6 and 7 that are joined by a first end wall 8 and a second end wall or cover 10 to collectively define an interior portion 12. First side wall 6 includes a first inner surface 16 and second side wall 7 includes a second inner surface 17. At this point it should be understood that housing 4 could also be constructed to include a single side wall having a continuous inner surface. Electric machine 2 is further shown to include a stator 24 arranged at first and second inner surfaces 16 and 17 of first and second side walls 6 and 7. Stator 24 includes a body 28, having a first end portion 29 that extends to a second end portion 30, which supports a plurality of windings 36. Windings 36 include a first end turn portion 40 and a second end turn portion 41.

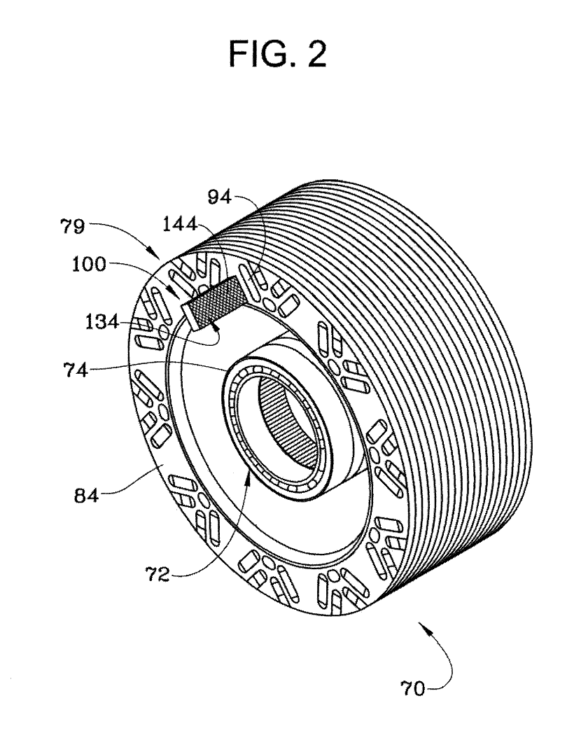

Electric machine 2 is also shown to include a shaft 54 rotatably supported within housing 4. Shaft 54 includes a first end 56 that extends to a second end 57 through an intermediate portion 59. Shaft 54 supports a rotor assembly 70. Rotor assembly 70 includes a hub 72 including a first bearing 74 that supports first end 56 relative to second end wall 10, and a second bearing 75 that supports second end 57 relative to first end wall 8. Rotor assembly 70 includes a rotor body 79 formed from a plurality of rotor laminations, one of which is indicated at 84. Each rotor lamination 84 includes a plurality of slots, one of which is indicated at 94 in FIG. 2. Rotor laminations 84 are stacked and slots 94 are aligned prior to undergoing a bonding process that forms rotor body 79. A plurality of permanent magnets (PM) 100, 101, and 102 are provided in rotor body 79 in slots 94.

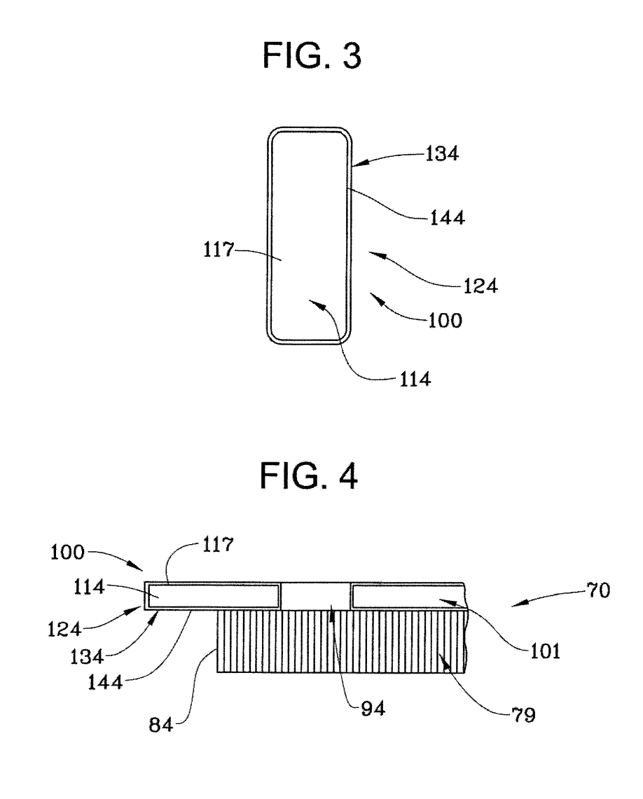

Reference will now be made to FIG. 3 in describing PM 100 with an understanding that PM 101 and PM 102 include similar structure. PM 100 includes a body 114 having an outer surface 117. In the exemplary embodiment shown, PM 100 is encased in a sacrificial coating 124. Sacrificial coating 124 includes a thermal interface material (TIM) 134 that facilitates heat exchange from PM 100. In accordance with one aspect of the exemplary embodiment TIM 134 possess a thermal conductivity of at least about 0.3 W/mK. In accordance with another aspect of the exemplary embodiment, TIM 134 is formed from a material having a cohesive shear strength that is less than an adhesive bonding strength. In accordance still another aspect of the exemplary embodiment, TIM 134 takes the form of a thermally conductive resin 144. The thermally conductive resin 144 may take the form of a B-stage resin. A B-stage resin is a resin in which a limited reaction between resin and hardener has been allowed to take place. The reaction is arrested while the resin remains flexible and soluble. The B-stage resin includes sufficient hardener that allows for subsequent hardening upon exposure to a hardening input such as heat or light of a particular wavelength. Thermally conductive resin 144 may also take the form of an epoxy based resin and/or a silicon based resin.

A portion of sacrificial coating 124 is removed upon insertion to, for example, slot 94. As best shown in FIG. 4, sacrificial coating 124 establishes an outer dimension of PM 100 that is greater than an inner dimension of slot 94. Upon insertion, a portion of sacrificial coating 124 is removed, shaved, broached, or scraped from PM 100. The partial removal of sacrificial coating 124 results from an interaction with rotor body 79. In this manner sacrificial coating 124 establishes an interference fit between PM 100 and rotor body 79. Accordingly, PM 100 is positively retained within rotor body 79 despite variations in dimension of slot 94 resulting from manufacturing tolerances. If/when using a B-stage coating, thermally conductive resin 144 is finally cured and hardened. For example, heat generated during operation of electric machine 2 may provide the desired hardening input required to fully harden thermally conductive resin 144.

At this point it should be understood that the exemplary embodiments provide permanent magnets in a PM electric machine with a sacrificial coating that not only establishes a desired retention between the permanent magnets and a rotor, but also facilitates heat removal. In addition, while described as being encapsulated in the thermally conductive resin, it should be understood that axial end portions of the permanent magnets may be devoid of any coating material. It should be further understood that the type and chemical make-up of the sacrificial coating may vary. Further, while shown and described as providing multiple permanent magnets in each slot, it should be understood that each slot may also be provided with a single permanent magnet. Further, it should be understood that there may exist slots that are not provided with magnets.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A permanent magnet electric machine comprising:
a housing;
a stator mounted within the housing; and
a rotor assembly rotatably mounted within the housing relative to the stator, the rotor assembly including a plurality of laminations, each of the plurality of rotor laminations including a plurality of slots and one or more permanent magnets mounted within one or more of the plurality of slots, each of the one or more permanent magnets including a sacrificial coating having a thermal interface material (TIM).

2. The permanent magnet electric machine according to claim 1, wherein the TIM comprises a thermally conductive resin.

3. The permanent magnet electric machine according to claim 2, wherein the thermally conductive resin comprises a B-stage resin.

4. The permanent magnet electric machine according to claim 2, wherein the thermally conductive resin comprises epoxy.

5. The permanent magnet electric machine according to claim 2, wherein the thermally conductive resin comprises silicon.

6. The permanent magnet electric machine according to claim 1, wherein the TIM possesses a thermal conductivity of at least about 0.3 W/mK.

7. A rotor for a permanent magnet electric machine comprising:
a plurality of laminations including a plurality of slots; and
one or more permanent magnets mounted within one or more of the plurality of slots, each of the one or more permanent magnets including a sacrificial coating having a thermal interface material (TIM).

8. The rotor according to claim 7, wherein the TIM comprises a thermally conductive resin.

9. The rotor according to claim 8, wherein the thermally conductive resin comprises a B-stage resin.

10. The rotor according to claim 8, wherein the thermally conductive resin comprises epoxy.

11. The rotor according to claim 8, wherein the thermally conductive resin comprises silicon.

12. The rotor according to claim 7, wherein the TIM possesses a thermal conductivity of at least about 0.3 W/mK.

13. A method of constructing a rotor for a permanent magnet electric machine, the method comprising:
stacking a plurality of rotor laminations;
aligning a plurality of slots formed in each of the plurality of rotor laminations;
joining the plurality of rotor laminations to form a rotor body;
inserting one or more permanent magnets including a sacrificial coating having a thermal interface material (TIM) into one or more of the plurality of slots; and
removing a portion of the sacrificial coating through an interaction between the one or more permanent magnets and one or more of the plurality of rotor laminations to establish an interference fit with the rotor body.

14. The method of claim 13, wherein removing a portion of the sacrificial coating includes scraping off a portion of a thermally conductive resin.

15. The method of claim 14, wherein scraping off a portion of the thermally conducive resin comprises removing a portion of a B-stage resin.

16. The method of claim 15, further comprising: curing the B-stage resin.

17. The method of claim 16, wherein curing the B-stage resin includes operating an electric machine including the rotor.

18. The method of claim 13, wherein scraping off a portion of the thermally conducive resin comprises removing a portion of epoxy.

19. The method of claim 13, wherein scraping off a portion of the thermally conducive resin comprises removing a portion of silicon.

20. The method of claim 13, wherein the TIM possesses a thermal conductivity of at least about 0.3 W/mK.
